(19) United States
(12) Patent Application Publication
(10) Pub. No.: US 2026/0208364 A1
(43) Pub. Date: Jul. 23, 2026

(54) UI-EQUIPPED END EFFECTOR

(71) Applicant: ARMA INC., Kakamigahara-shi (JP)

(72) Inventor: Takashi FURUTA, Kakamigahara-shi (JP)

(21) Appl. No.: 19/569,604

(22) Filed: Mar. 17, 2026

Related U.S. Application Data
(63) Continuation of application No. PCT/JP2024/032190, filed on Sep. 9, 2024.

(30) Foreign Application Priority Data
Sep. 19, 2023 (JP) 2023-150654

(51) Int. Cl. B25J 9/16; B25J 13/00; B25J 13/06; B25J 15/00

(52) U.S. Cl. CPC B25J 9/1697; B25J 13/06; B25J 13/003; B25J 15/0028

(57) ABSTRACT

Provided is a UI-equipped end effector with which :autonomy of the end effector in direct teaching of a robot or the like makes it possible to control operation of work units or the like and further improve efficiency and accuracy; a state or condition of a robot system can be checked with the end effector, without checking at an indicator of an operation panel of the robot system, thus enabling a worker to respond and coordinate with the robot system; and work that has higher added value is easier and less expensive to implement. This UI-equipped end effector 1 can be connected to a distal end of a robot arm 80, the UI-equipped end effector comprising a work unit 2, a work drive unit 3 for driving the work unit 2, a user interface 4 equipped with a display, and a control unit 5 able to control the work drive unit 3 and the user interface 4 independently.

### TECHNICAL FIELD

The present invention relates to a UI-equipped end effector connectable to distal ends of robotic arms.

### BACKGROUND ART

Various types of end effectors connectable to a distal end of a robot arm have conventionally been proposed. For example, such end effectors include one described in Japanese Patent No. 7084135, as published in the official gazette. These conventional end effectors are configured to operate under control from a control panel of the robot system alongside the robot arm. Furthermore, the conventional end effectors lack a user interface (UI) and cannot be independently controlled based on input from a user interface.

More specifically, for example, movements of a robot and movements of an end-effector are taught in direct teaching for the robot. However, when a work unit of the end-effector is, for instance, a gripper that grasps a target workpiece, the gripping force (torque) and the grasping speed need be set in advance. In other words, in the conventional direct teaching, settings of the gripping force and the speed are directly controlled via an input/output (I/O) assigned to the end effector using a teaching pendant, so that the gripping force (torque) and the speed cannot be adjusted while the inching operation is being performed with the gripper.

Furthermore, since the end effector attached to the robot operates according to commands from the robot, the end effector cannot independently operate the work unit (such as opening/closing of the gripper) during teaching.

Still furthermore, an end effector with high performance control other than on-off control need be assigned to a robot or connected to a control panel of the robot system.

Furthermore, even when a plurality of robots and workers work together, the plural robots are controlled from a control panel in the robot system, and an operation panel is basically composed of a single panel. Consequently, there arises a problem that the production status and the like upon occurrence of an error can only be confirmed via a display of the operation panel of the robot system.

Furthermore, there also arises a problem of increased costs when a plurality of control panels are required in order that a highly coordinated work using multiple robots may be performed.

### PRIOR ART DOCUMENT

### Patent Documents

[Patent Document 1] Japanese Patent No. 7084135

### SUMMARY OF THE INVENTION

### Problem to Be Overcome by the Invention

Therefore, the inventor of the present application has conceived an invention capable of resolving the aforementioned problems comprehensively. More specifically, an object of the present invention is to provide a UI-equipped end effector that can independently control the operation of the work unit during tasks such as direct teaching for the robot, thereby further enhancing efficiency and accuracy; that can allow the status and conditions of the robot system to be checked directly on the end effector itself without checking the display on the control panel of the robot system; and from which the operator can obtain information without going through the robot system's operation panel or control panel, thereby enabling him/her to respond to and coordinate with the robot system, whereupon the end effector can perform higher value-added tasks more easily and cost-effectively.

### Means for Overcoming the Problem

What solves the above problem is a UI-equipped end effector that can be connected to the distal end of a robot arm and includes a work unit, a work drive unit for driving the work unit, and a user interface (UI) with a display.

The user interface (UI) may be a touch-panel display. The UI-equipped end effector may include a control unit capable of independently controlling the work drive unit and the user interface (UI). The UI-equipped end effector may include a microphone and a loudspeaker, and the microphone and the loudspeaker may be configured to be independently controlled from the control unit. The UI-equipped end effector may include a gyroscope sensor, and the gyroscope sensor may be configured to be independently controlled from the control unit. The UI-equipped end effector may include a camera, and the camera may be configured to be independently controlled from the control unit. The UI-equipped end effector may include a communication device, and the communication device may be configured to be independently controlled from the control unit. The UI-equipped end effector may include a temperature sensor, and the temperature sensor may be configured to be independently controlled from the control unit.

### Effect of the Invention

According to the end effector described in claim 1, the end effector can independently control the operation of the working section during tasks such as direct teaching for the robot, thereby further enhancing efficiency and accuracy; the end effector can allow the status and conditions of the robot system to be checked directly on the end effector itself without checking the display on the control panel of the robot system; and the operator can obtain information from the end effector without going through the robot system's operation panel or control panel, thereby being capable of responding to and coordinating with the robot system, whereupon the end effector can perform higher value-added tasks more easily and cost-effectively.

According to the UI-equipped end effector described in claim 2, the end effector can independently control the operation of the work unit during tasks such as direct teaching for the robot, thereby further enhancing efficiency and accuracy; the end effector can allow the status and conditions of the robot system to be checked directly on the end effector itself without checking the display on the control panel of the robot system; and the operator can obtain information from the end effector without going through the robot system's operation panel or control panel, thereby being capable of responding to and coordinating with the robot system, whereupon the end effector can perform higher value-added tasks more easily and cost-effectively.

According to the UI-equipped end effector described in claim 3 or claim 4, the end effector can independently control the operation of the work unit during tasks such as direct teaching for the robot, thereby further enhancing efficiency and accuracy; the end effector can allow the status and conditions of the robot system to be checked directly on the end effector itself without checking the display on the control panel of the robot system; and the worker can obtain information from the end effector without going through the robot system's operation panel or control panel, thereby being capable of responding to and coordinating with the robot system, whereupon the end effector can perform higher value-added tasks more easily and cost-effectively. In particular, the robot system operates the robot arm to move the work unit (gripper) holding the target workpiece near the worker. The target workpiece can be discharged from the machine when the operator determines the workpiece to be defective. The end effector can realize higher value-added tasks more easily and cost-effectively by utilizing the user interface (UI) and collaborating with the robotic system.

According to the UI-equipped end effector described in claim 5, the end effector can independently control the operation of the work unit during tasks such as direct teaching for the robot, thereby further enhancing efficiency and accuracy; the end effector can allow the status and conditions of the robot system to be checked directly on the end effector itself without checking the display on the control panel of the robot system; and the operator can obtain information from the end effector without going through the robot system's operation panel or control panel, thereby being capable of responding to and coordinating with the robot system, whereupon the end effector can perform higher value-added tasks more easily and cost-effectively. In particular, defect details can be shown to the operator for each defect via the user interface (UI) in the defect confirmation inspection. The end effector can realize higher value-added tasks more easily and cost-effectively by utilizing the user interface (UI) and collaborating with the robot system.

According to the UI-equipped end effector described in claim 6, the UI-equipped end effector from which the effect of any one of the above claims is achieved can be constructed easily and cost-effectively.

According to the UI-equipped end effector described in claim 7, in addition to the effect of any one of the above claims, voice control enables communication with the operator, improving workability and productivity.

According to the UI-equipped end effector described in claim 8, in addition to the effect of any one of the above claims, collaboration with external devices and networks such as the Internet is possible, enabling higher value-added tasks to be achieved more easily.

### BRIEF DESCRIPTION OF THE DRAWINGS

FIGS. 1A, 1B and 1C are respectively a front view, a right-side view and a perspective view of an embodiment of the UI-equipped end effector according to the present invention, showing an external appearance thereof.

FIG. 2 shows an example of the configuration of a robot system using the UI-equipped end effector shown in FIGS. 1A, 1B and 1C.

FIG. 3 is a connection diagram of the UI-equipped end effector in the robot system shown in FIG. 2.

FIG. 4 is a functional block diagram of the UI-equipped end effector shown in FIGS. 1a, 1b and 1c.

FIG. 5 is an explanatory diagram for explaining the operation of the UI-equipped end effector shown in FIGS. 1a, 1b and 1c (the operation during direct teaching), depicting the display screen of the touch panel display.

FIG. 6 is an explanatory diagram for explaining the operation of the UI-equipped end effector shown in FIGS. 1A, 1B and 1C (the operation during direct teaching), depicting the display screen of the touch panel display.

FIG. 7 is an explanatory diagram for explaining the operation of the UI-equipped end effector shown in FIGS. 1A, 1B and 1C (the operation during direct teaching), depicting the display screen of the touch panel display.

FIGS. 8A and 8B are explanatory diagrams for explaining another operation of the UI-equipped end effector (the operation during confirmation inspection by the operator), FIG. 8A being the explanatory diagram for explaining the inspection status and FIG. 8B depicting the display screen of the touch panel display.

FIGS. 9A and 9B are explanatory diagrams for explaining another operation of the UI-equipped end effector (the operation during confirmation inspection by the worker), FIG. 9A being the explanatory diagram for explaining the inspection status and FIG. 9B depicting the display screen of the touch panel display.

FIGS. 10A and 10B are explanatory diagrams for explaining another operation of the UI-equipped end effector (the operation during confirmation inspection by the operator), FIG. 10A being the explanatory diagram for explaining the inspection status and FIG. 10B depicting the display screen of the touch panel display.

FIG. 11 is an explanatory diagram for explaining another operation of the UI-equipped end effector shown in FIGS. 1A and 1B.

FIGS. 12A, 12B and 12C are respectively a front view, a right-side view and a perspective view of another embodiment of the UI-equipped end effector according to the present invention, depicting an external appearance thereof.

### BEST MODE FOR CARRYING OUT THE INVENTION

The present invention realizes a UI-equipped end effector including a work unit 2 including a gripper, a work drive unit 3 for driving the work unit 2, a user interface 4 and a control unit 5 capable of independently controlling the work drive unit 2 and the user interface 4, whereupon the end effector independently controls the operation of the work unit and the like on the occasion of the direct teaching for the robot, thereby being capable of improving the efficiency and the accuracy, confirming the status and condition of the robot system at the end effector without confirmation on the display of the operation panel in the robot system, wherein when obtaining information from the end effector without via the operation panel and the control panel of the robot system, the operator can respond to and realize collaboration with the robot system, with the result that higher added-value work can be performed more easily and at lower cost.

### Embodiment 1

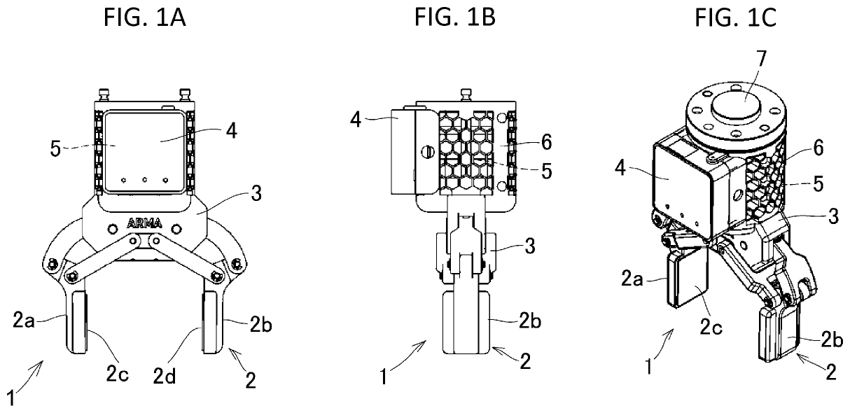

The UI-equipped end effector of the present invention will be described using an embodiment thereof as shown in FIGS. 1A through 11.

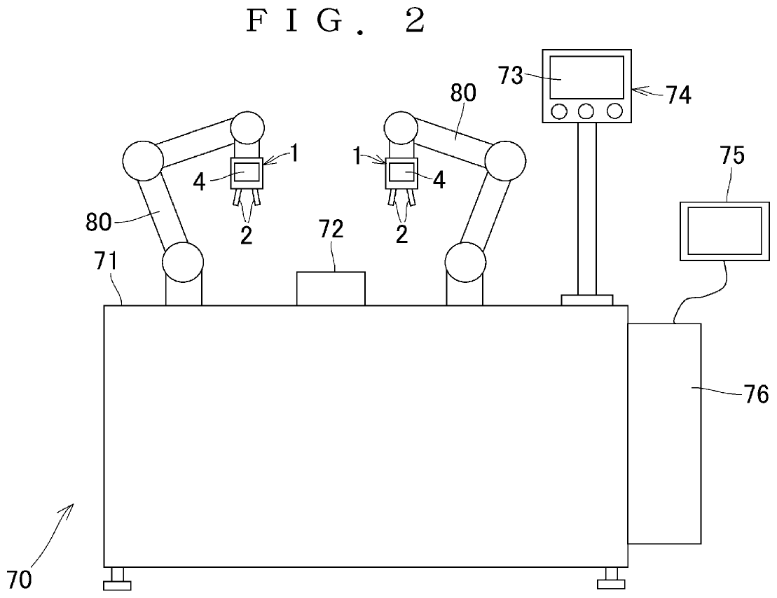

The UI-equipped end effector of the embodiment is a UI-equipped end effector connectable to a distal end of a robot arm 80 and includes a work unit 2, a work drive unit 3 for driving the work unit 2, a user interface 4 with a display and a control unit 5 capable of independently controlling the work drive unit 3 and the user interface 4, as shown in FIGS. 1A-1C or FIG. 2. Each component will be described in detail in sequence below.

The end effector 1 of the embodiment is connected to distal ends of the robot arms 80 in a robot system 70 shown in FIG. 2, for example, thereby to be used as a robot hand.

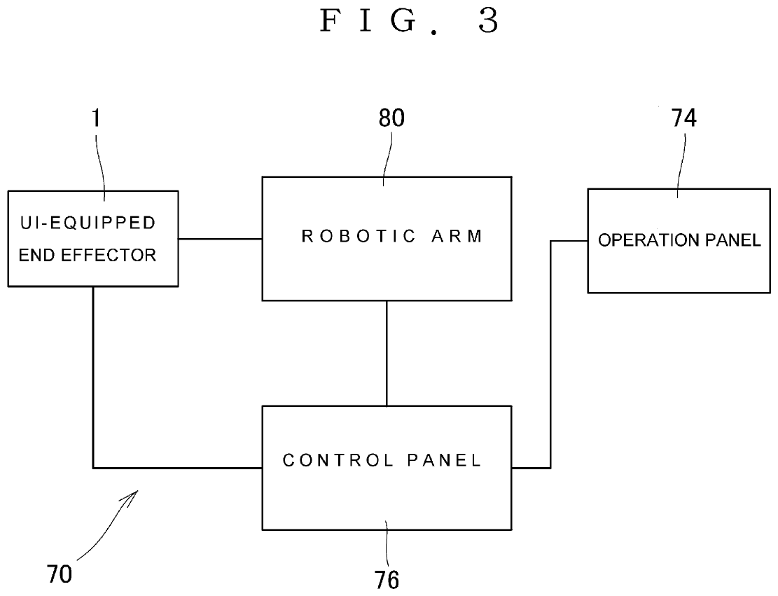

The robot system 70 includes a work table 72 mounted on a machine base 71, an operation panel 74 provided with a display 73, a robot teaching pendant 75, robot arms 80, the UI-equipped end effectors 1 connected to distal ends of the robot arms 80 and a control panel 76 capable of controlling the operation panel 74, the robot teaching pendant 75, the robot arms 80 and the UI-equipped end effectors 1. The UI-equipped end effectors 1 of the embodiment are connected to the control panel 76 together with the operation panel 74 and the robot arms 80 so as to be configured to be controllable by the operation of the operation panel 74, as shown in FIG. 3.

The work unit 2 is the part that contacts a target workpiece to perform various operations. In the embodiment, the work unit 2 comprises a gripper equipped with a pair of gripping hands 2a and 2b, as shown in FIGS. 1A-1C. More specifically, the work unit 2 in the embodiment is a work unit of a type that performs the work by clamping or releasing the target workpiece between the flat inner surfaces 2c and 2d of the gripping hands 2a and 2b as the flat inner surfaces 2c and 2d of the gripping hands 2a and 2b move closer to or farther apart.

However, the work unit in the UI-equipped end effector of the present invention should not be limited to the grasping gripper but encompasses various types of working units according to work contents, such as vacuum hands and magnetic hands. Furthermore, tasks performed by the work unit of the UI-equipped end effector include, for example, screw tightening, assembly, part sorting, alignment, boxing, picking, transport, coating, inspection, and measurement.

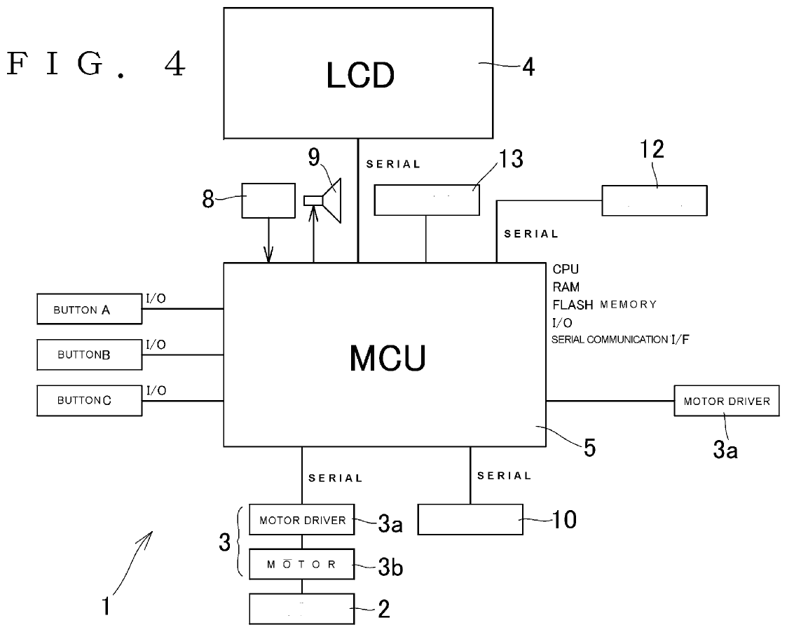

The work drive unit 3 is provided for driving the work unit 2, and the work drive unit 3 in the embodiment has a motor driver 3a and an electric motor 3b (a servomotor capable of detecting torque), as shown in FIG. 4. Furthermore, the work drive unit 3 has a plurality of motor drivers 3a to enable more complex movements of the work drive unit 3 in the embodiment. However, the work drive unit in the UI-equipped end effector of the present invention is not limited to one having an electric motor as in the embodiment. It broadly encompasses drive devices such as hydraulic or pneumatic systems, as well as mechanical elements like electromagnets, springs, link mechanisms, or cam mechanisms, which operate the work unit according to the type of work unit.

The work unit 2 and an exterior 6 such as the work drive unit 3 of the UI-equipped end effector 1 may be made using a 3D printer, so that it is possible to configure highly flexible work unit and exterior tailored to specific workpieces that cannot be accommodated by mass-produced items. Furthermore, resin materials are preferred for forming the work unit and the exterior due to their lightweight properties, but these parts may also be formed from metal materials. Furthermore, one end of the exterior 6 is provided with a mount 7 for connection to a distal end of a robot arm 80.

The user interface (UI) 4 equipped with a display is one of characteristic configurations of the UI-equipped end effector of the present invention, and a touch panel display is used as the user interface 4. However, the user interface (UI) equipped with the display in the UI-equipped end effector of the present invention should not be limited to the touch panel display but may be a combination of a display and an input device (e.g., a device with selectable buttons) through which the user inputs information. Furthermore, the user interface 4 should not be limited to one having a contact-type input device such as the touch panel display but may also have a non-contact input device that receives information from the user via sensors, voice, or other means. In this application, the term “user interface” refers to an interface through which a user (e.g., an operator) exchanges information with a control unit.

Furthermore, the control unit (controller) 5 is configured to be able to independently control the operation of each part of the UI-equipped end effector 1 (e.g., the work unit 2, the work drive unit 3 and the touch panel display 4) or the operation of each part connected to the UI-equipped end effector 1 (e.g., a microphone 8, a loudspeaker 9, a gyroscope sensor 10, a camera 11, a communication device 12, a temperature sensor 13) connected to the UI-equipped end effector 1.

The UI-equipped end effector of the embodiment has the liquid crystal display (LCD) 4 serving as the touch panel, the buttons A, B and C all of which are displayed on the touch panel, so that a user interface (UI) is configured so that information can be input to the UI-equipped end effector therethrough and output to the user (e.g., the operator) therethrough.

However, the user interface (UI) in the UI-equipped end effector of the present invention should not be limited to the touch panel display 4. In addition to the touch panel display 4 or a display, the scope of the present invention broadly encompasses user interfaces provided by other means (e.g., keyboard, mouse, microphone 8, loudspeaker 9).

The control unit 5 is a controller that enables independent control of the work drive unit 3 and the touch panel display 4, etc. from the control panel 76 of the robot system 70, and is provided within the UI-equipped end effector 1. Consequently, even when control is complicated and difficult to perform using the control panel of a connected robot system, the control can be set up so as to be performed simply and inexpensively on the UI-equipped end effector side by additionally setting a more detailed grasping control (e.g., the control for grasping soft workpieces) at the UI-equipped end effector side or by replacing the UI-equipped end effector with one specialized for detailed control, on the control panel 76 of the robot system 70.

Specifically, the control unit 5 is a controller that enables independent control of the work drive unit 3 and the touch panel display 4, etc. from the control panel 76 of the robot system 70, and is provided within the UI-equipped end effector 1, as shown in FIGS. 1A-1C. Consequently, even when control is complicated and difficult to perform using the control panel of a connected robot system, the control can be set up so as to be performed simply and inexpensively on the UI-equipped end effector side by additionally setting a more detailed grasping control (e.g., the control for grasping soft workpieces) at the UI-equipped end effector side or by replacing the UI-equipped end effector with one specialized for detailed control, on the control panel 76 of the robot system 70.

More specifically, the control unit 5 (controller) in the embodiment is configured with a microcontroller unit (MCU) and incorporates a central processing unit(CPU), RAM, flash memory, SD card, etc. The control unit 5 is configured to perform data or information input/output processing with other units, data calculation processing, data or information storage processing, and various program writing tasks. The control unit 5 is configured to be capable of comprehensively controlling and supervising the operation of various components such as the work drive unit 3, touch panel display (LCD) 4, microphone 8, loudspeaker 9, gyro sensor 10, camera 11, communication device 12, or temperature sensor 13 based on various programs (OS, application software), etc. Note that the configuration of the control unit 5 (controller) shown in FIG. 4 is merely one example. The control unit 5 need not necessarily include all of the above components, and may additionally include further components.

The microphone 8 and the loudspeaker 9 transmit information from the operator to the control unit 5 via voice and convey information from the control unit 5 to the operator via voice. The microphone 8 and the loudspeaker 9 function as a type of user interface(UI) (a second user interface). By configuring the microphone 8 and the loudspeaker 9 as input/output components for voice control, communication becomes possible between the operator and the control unit 5, with the result of further improvement of operability and productivity.

The gyroscope sensor 10 functions as a component that enables easier alignment by allowing confirmation of posture of the work unit 2, thereby enabling detection capabilities superior to collision detection of a robot.

The camera 11 is a component designed for remote monitoring, motion recording, and accurate recognition of images such as target workpieces, barcodes, and characters.

The communication device 12 is a component that communicates with external devices and networks such as the Internet to collaborate with the UI-equipped end effector, and may be a wired communication device, or alternatively, a wireless communication device using technologies such as Wi-Fi® or Bluetooth®. This enables collaboration with external devices and networks, making it easier to achieve tasks with higher added value.

The temperature sensor 13 is provided to enable more accurate execution of tasks requiring temperature control. Note that the components controlled by the control unit 5 in the above embodiment are merely one examples. The control unit of the UI-equipped end effector of the present invention should not be necessarily limited to controlling all of the above-described components and may also control additional components.

Next, examples of the operation of the UI-equipped end effector 1 of the present invention will be sequentially described.

The direct teaching is a method in which the worker directly moves the UI-equipped end effector 1 with his or her hands to have the robot learn the motion. The UI-equipped end effector 1 of this embodiment has the servomotor 3b and the gyroscope sensor 10 that can detect torque, calculates torque, speed, rotational angle, etc., based on input from the worker via the touch panel display 4 or direct motion instructions given to the UI-equipped end effector 1, and stores calculation results as robot programming. The UI-equipped end effector 1 is configured such that stored motions and controls (torque control, speed control, positioning control, etc.) are repeatedly fed back so that various tasks are executed. Therefore, condition setting need not be carried out on a personal computer, and the direct teaching can be carried out extremely easily.

More specifically, in the UI-equipped end effector 1 of the embodiment, when the button B is pressed by the operator on an initial screen 25 of the touch panel display 4, the control unit 5 controls the gripper (work unit) 2 having a pair of gripping hands 2a, 2b to be opened. Conversely, when the button C is pressed, the control unit 5 controls the gripper (work unit) 2 to be closed. This allows the operator performing the motion teaching (teaching) to open and close the gripper (work unit) 2 while the operator is directly moving the UI-equipped end effector 1 by hand to teach the motion, making teaching more accurate and easier.

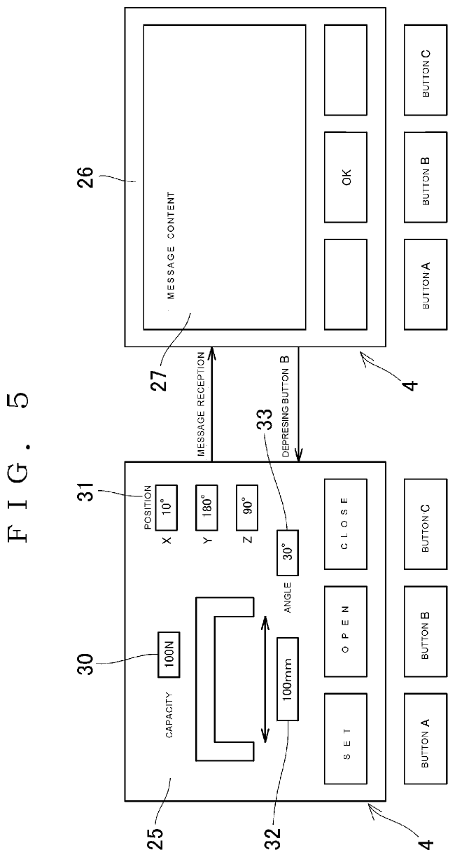

Furthermore, the touch panel display 4 is configured to display a torque indication 30, a position indication 31 via the gyroscope sensor, a travel distance 32 calculated from a motor drive amount and an angle 33 on the initial screen 25. Furthermore, the touch panel display 4 is configured to automatically switch from the initial screen 25 to a message display (pop-up) screen 26 upon receipt of a message for the worker, as shown in the right part of FIG. 5, displaying the message contents 27 on the touch panel display 4. When the worker confirms the message contents and presses the button B, it is recognized as OK (indicating that the worker has acknowledged the message content), and the touch display panel 4 is configured to return to the initial screen 25. This enables the system to convey information to the worker via the touch panel display 4, thereby functioning to improve operability or productivity.

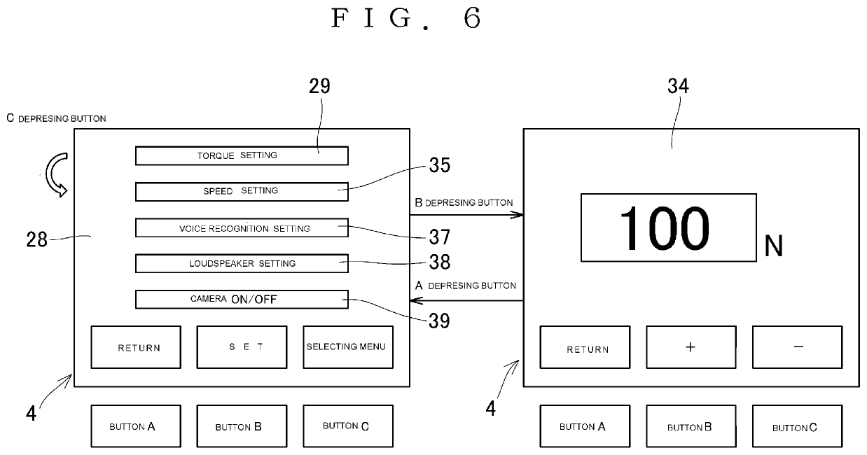

Furthermore, when wishing to set torque for the gripper (work unit) 2, the worker presses the button A on the initial screen 25 as shown in FIG. 5. A setting screen 28 is then displayed on the touch panel display 4 as shown in FIG. 6. When a torque setting 29 is pressed on the setting screen 28 and the button B (setting) is then pressed, a torque setting screen 34 as shown in the right part of FIG. 6 is displayed. Torque is increased by pressing the button B or decreased by pressing the button C, so that the torque is determined. Thereafter, the touch panel display 4 is returned to the setting screen 28 by pressing the button A, and the torque is set. Consequently, the grip force (torque) of the work unit 2 can be set even while the worker is performing an inching motion with the gripper (work unit) 2.

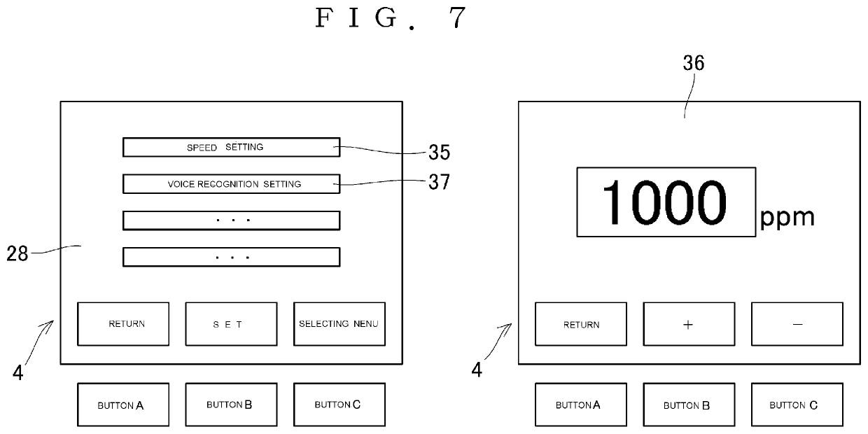

On the other hand, when wishing to set speed of the gripper (work unit) 2, the worker presses the button C on the setting screen 28 of the touch panel display 4 as shown in FIG. 5, so that the touch panel display 4 is switched to a speed setting 35 (the left part of FIG. 7). When the button B (setting) is pressed, a speed setting screen 36 as shown in the right part of FIG. 7 is displayed. The speed is increased by pressing the button B or decreased by pressing the button C. When the button A is pressed after the speed has been determined, the display 4 is returned to the setting screen 28 and the speed is set. Consequently, the speed of the work unit 2 can be set even while the worker is performing an inching motion with the gripper (work unit) 2.

Furthermore, the operator can perform a voice recognition setting 37, a loudspeaker setting 38, a camera ON/OFF setting 39 and the like on the setting screen 28 shown in FIG. 6. The UI-equipped end effector 1 is configured to independently perform controls other than control of the work unit 2, the work drive unit 3, and the touch panel display 4.

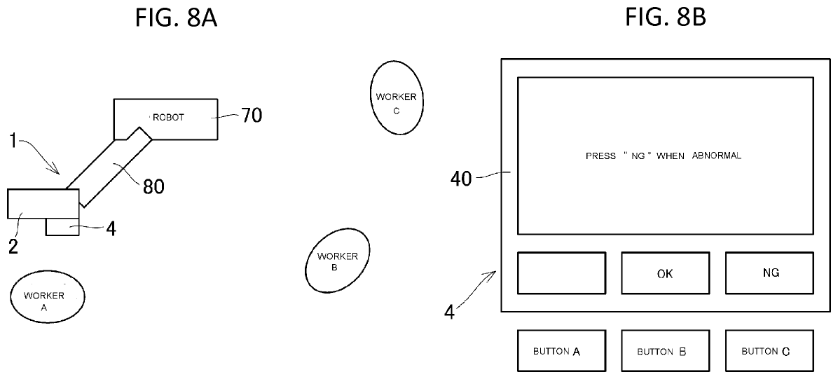

Next, another example of operation of the UI-equipped end effector 1 of the present invention shown in FIGS. 8A and 8B to 10A and 10B will be described.

The operation of the UI-equipped end effector 1 shown in FIG. 8A to 10B is an inspection in which workers A, B, and C, who are positioned in different positions, visually inspect the target workpiece (not shown) gripped by the work unit (gripper) 2 to check whether it is normal or abnormal.

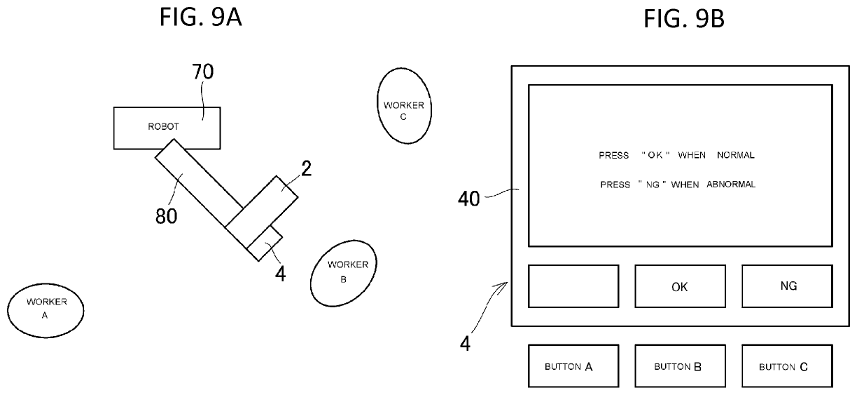

More specifically, the robot system 70 causes the robot arm 80 to operate, so that the work unit (gripper) 2 grasping the target workpiece is moved to the worker A side, as shown in FIG. 8A. When visually inspecting the target workpiece and determining that it is normal, the worker A presses the button B on the inspection determination screen 40 displayed on the touch panel display 4, as shown in FIG. 8B. This indicates approval for the worker A, allowing the process to proceed to inspection by the next worker B. The robot system 70 then operates the robot arm 80 to move the gripper 2 grasping the workpiece to the worker B side, as shown in FIG. 9A. On the other hand, when visually inspecting the target workpiece and determining that it is abnormal, the worker A presses the button C on the inspection determination screen 40 of the touch panel display 4, with the result of an NG determination. The target workpiece is ejected from the machine as a defective.

Next, when visually inspecting the target workpiece and determining that is normal, the worker B presses the button B on the inspection determination screen 40 of the touch panel display 4, as shown in FIG. 9B. This indicates approval by the worker B as well, allowing the process to proceed to inspection by the next worker C. In order to proceed to inspection by the worker C, the robot system 70 operates the robot arm 80 to move the gripper 2 with the workpiece being grasped to the worker C side.

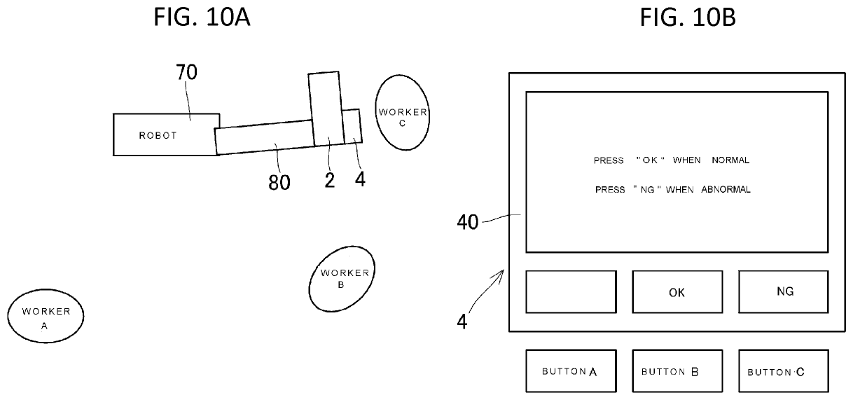

Furthermore, when visually inspecting the target workpiece and determining that it is normal, the worker C presses the button B of the inspection determination screen 40 on the touch panel display 4, as shown in FIG. 10B. This indicates approval by the worker C as well, allowing the process to proceed to a product discharge process. On the other hand, when visually inspecting the target workpiece and determining that it is abnormal, the worker C presses the button C of the inspection determination screen 40 on the touch panel display 4, with the result of an NG determination. The target workpiece is ejected from the machine as a defective.

Thus, the UI-equipped end effector 1 of the present invention enables the realization of higher value-added tasks more easily and at lower cost by utilizing the touch panel display 4 (UI) and collaborating with the robot system 70.

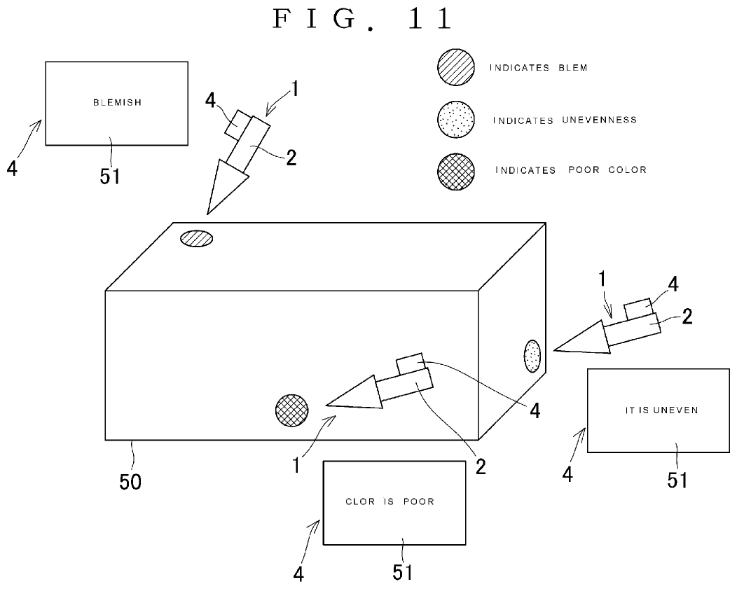

Furthermore, another example of the operation of the UI-equipped end effector 1 of the present invention shown in FIG. 11 will be described.

The operation of the UI-equipped end effector 1 shown in FIG. 11 is a defect confirmation inspection in which the work unit (gripper) 2 indicates a defective part of the target workpiece 50 and displays defect contents on a defect display screen 51 of the touch panel display 4.

More specifically, when the defective part of the target workpiece 50 is found by the camera 11, the robot system 70 causes the robot arm 80 to operate, so that the work unit (gripper) 2 points to the defective part, as shown in FIG. 11. The control unit 5 of the UI-equipped end effector 1 determines whether or not the defect is a blem, an unevenness, or poor color, and controls the touch panel display 4 to display the content of the determination (defect content) on the defect display screen 51 of the touch panel display 4. Consequently, the workers can easily inspect and confirm the presence or absence of defects and the defect contents for each target workpiece 50.

Thus, the UI-equipped end effector of the present invention can show the defect contents for each defective part to the workers via the touch panel display 4 (UI) in the defect inspection. The UI-equipped end effector of the present invention enables the realization of higher value-added tasks more easily and at lower cost in collaboration with the robot system 70.

The operations of the UI-equipped end effector of the present invention as shown in FIGS. 5 to 11 are mere examples, and the UI-equipped end effector of the present invention includes a user interface with a display (e.g., a touch panel display: UI) or a user interface with a display (a touch panel display) and another interface and encompasses UI-equipped end effectors that can achieve higher value-added tasks more easily and at lower costs through the operation realized by the control unit independently controlling the user interfaces and the operation realized by the collaboration between the above control manners and the robot system.

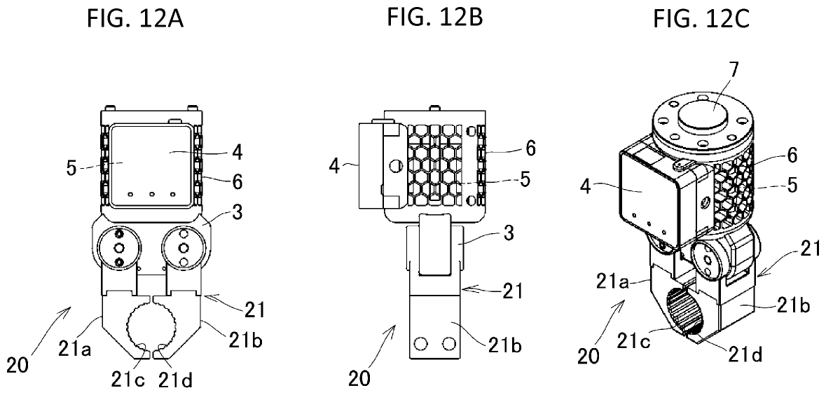

Furthermore, another embodiment of the UI-equipped end effector of the present invention will be described with reference to FIGS. 12A, 12B and 12C.

The UI-equipped end effector 20 of this embodiment is basically different from the UI-equipped end effector 1 described above only in the configuration of the work unit and similar in the other respects. The same components as those of the UI-equipped end effector 1 are designated by the same reference numerals and the description of the same components will be eliminated.

The work unit 21 in this embodiment is also configured as a gripper having a pair of gripping hands 21a and 21b. More specifically, the work unit 21 of this embodiment is configured to perform a task by clamping or releasing a cylindrical or columnar target workpiece between substantially semicircular inner surfaces 21c and 21d of the gripping hands 21a and 21b, which are arranged opposite to each other, as the substantially semicircular inner surfaces 21c and 21d in a front view move closer to or away from each other. Thus, the work unit of the UI-equipped end effector of the present invention broadly encompasses various types according to task contents and types of the target workpieces.

### EXPLANATION OF REFERENCE SYMBOLS

1 UI-equipped end effector
2 work unit
3 work drive unit
4 user interface with a display (touch panel display)
5 control unit
6 exterior
7 mount
8 microphone
9 loudspeaker
10 gyroscope sensor
11 camera
12 communication device
13 temperature sensor
20 UI-equipped end effector
21 work unit
70 robot system
71 machine base
72 work table
73 display
74 operation panel
75 robot teaching pendant
76 operation panel
80 robot arm

1. A UI-equipped end effector connectable to a distal end of a robot arm, comprising:
a work unit including a gripper;
a work drive unit for driving the work unit;
a user interface (UI); and
a control unit capable of independently controlling the work drive unit and the user interface,
wherein the control unit is configured to be capable of opening and closing the gripper of the work unit via the user interface.

2. A UI-equipped end effector connectable to a distal end of a robot arm, comprising:
a work unit;
a work drive unit for driving the work unit;
a user interface (UI); and
a control unit capable of independently controlling the work drive unit and the user interface,
wherein the control unit is configured to be capable of performing torque control, speed control or positioning control for the work unit via the user interface.

3. A UI-equipped end effector connectable to a distal end of a robot arm, comprising:
a work unit including a gripper;
a work drive unit for driving the work unit;
a user interface (UI); and
a control unit capable of independently controlling the work drive unit and the user interface,
wherein the UI-equipped end effector is moved by a robot system controlling operation of the robot arm to a position where a worker can inspect a target workpiece grasped by the gripper of the work unit; and
wherein when determining that there is an abnormality in the target workpiece, based on a normal/abnormal signal received from the operator via the user interface (UI), the control unit controls the work drive unit so that the target workpiece is externally discharged.

4. The UI-equipped end effector according to claim 3, wherein the control by the robot system and the control unit is performed for a plurality of works located at different positions.

5. A UI-equipped end effector connectable to a distal end of a robot arm, comprising:
a work unit including a gripper;
a work drive unit for driving the work unit;
a user interface (UI); and
a control unit capable of independently controlling the work drive unit and the user interface,
wherein when a camera finds a defective part in a target workpiece, a robot system causes the robot arm to operate so that the defective part is pointed to by the work unit and the control unit is configured to determine defect content of the defective part and to display the determined defect content on a display of the user interface (UI).

6. The UI-equipped end effector according to claim 1, wherein the user interface (UI) is a touch panel display.

7. The UI-equipped end effector according to claim 2, wherein the user interface (UI) is a touch panel display.

8. The UI-equipped end effector according to claim 3, wherein the user interface (UI) is a touch panel display.

9. The UI-equipped end effector according to claim 5, wherein the user interface (UI) is a touch panel display.

10. The UI-equipped end effector according to claim 1, further comprising a microphone and a loudspeaker, wherein the microphone and the loudspeaker are configured to be independently controlled by the control unit.

11. The UI-equipped end effector according to claim 2, further comprising a microphone and a loudspeaker, wherein the microphone and the loudspeaker are configured to be independently controlled by the control unit.

12. The UI-equipped end effector according to claim 3, further comprising a microphone and a loudspeaker, wherein the microphone and the loudspeaker are configured to be independently controlled by the control unit.

13. The UI-equipped end effector according to claim 5, further comprising a microphone and a loudspeaker, wherein the microphone and the loudspeaker are configured to be independently controlled by the control unit.

14. The UI-equipped end effector according to claim 1, further comprising a communication device, wherein the communication device is configured to be independently controlled by the control unit.

15. The UI-equipped end effector according to claim 2, further comprising a communication device, wherein the communication device is configured to be independently controlled by the control unit.

16. The UI-equipped end effector according to claim 3, further comprising a communication device, wherein the communication device is configured to be independently controlled by the control unit.

17. The UI-equipped end effector according to claim 5, further comprising a communication device, wherein the communication device is configured to be independently controlled by the control unit.
